(19) United States
(12) Patent Application Publication
(10) Pub. No.: US 2016/0153641 A1
(43) Pub. Date: Jun. 2, 2016

(54) RETROFIT KIT FOR RECESSED LIGHT FIXTURES AND RETROFITTING METHOD

(71) Applicant: GE LIGHTING SOLUTIONS, LLC, East Cleveland, OH (US)

(72) Inventors: Min Fang, Shanghai (CN); Matthew A. Bugenske, East Cleveland, OH (US); Yingchun Fu, Shanghai (CN); Jianxue He, Shanghai (CN)

(21) Appl. No.: 14/950,020

(22) Filed: Nov. 24, 2015

(30) Foreign Application Priority Data
Nov. 28, 2014 (CN) 201410710842.6

(51) Int. Cl. F21V 7/16; F21V 7/05; F21K 99/00; F21V 7/00

(52) U.S. Cl. CPC F21V 7/16; F21V 7/005; F21V 7/05; F21K 9/175; F21Y 2101/02; F21Y 2103/003

(57) ABSTRACT

A retrofit kit adapted to existing recessed light fixtures having housings of different depths and/or configurations is described herein. The retrofit kit includes a flat flexible reflector and at least one pair of fasteners adapted to secure the flat flexible reflector in the housing of an existing recessed light fixture. The reflector can be flexed to different curved shapes to fit the housings. A retrofitting method for an existing recessed light fixture is also disclosed.

### BACKGROUND OF THE INVENTION

Embodiments of the present invention generally relate to a retrofit kit and a retrofitting method for existing recessed light fixtures having housings of different depths and/or configurations.

New lighting technologies provide light sources and power components with better energy efficiency than those used in the past. For example, light emitting diodes (LEDs) are widely utilized to replace fluorescent lights. Generally, the expense of replacing an entire light fixture previously installed is high. It is less expensive to keep the housing of an existing light fixture and replace or eliminate some components in the housing, which can also take advantages of the improvements in lighting technologies. Recently, efforts have been made to retrofit kit for facilitating quick and easy installation of a light source to an existing light fixture. A retrofit kit usually contains a new light module containing at least one light source, a reflector for increasing the intensity of light, and a power supply component. The reflector usually has a curved shape and is adapted to the housing of the existing light fixture, that is, the edge of the reflector should bias against the side wall of the housing after installation. If the reflector does not fit the housing, there will be a gap between the edge of the reflector and the side wall of the housing, and a shadow area may be formed when the retrofitted light fixture is powered on. The existing light fixtures may have openings of different sizes and housings of different depth and/or configurations. Accordingly customized reflectors are required to fit various light fixtures.

There are needs for retrofitting existing recessed light fixtures mounted in ceiling planes, grounds or other places. Each recessed light fixture has a housing installed into a ceiling or other places and an opening from which the light shines. The openings have various sizes and shapes, such as rectangular and circular, which are defined by industry standards. For example, the common used sizes of rectangular openings include 4 ft by 2 ft, 2 ft by 2 ft and 4 ft by 1 ft. Within the context of embodiments of the invention, the “opening size” is understood to mean the outer opening size considering the thickness of the housing or the hollow size of the ceiling or other places where the recessed light fixture is installed. However, even if the recessed light fixtures have the same sized opening, their housings provided by different suppliers may have various depths and/or configurations. The traditional reflectors for recessed light fixtures are relatively rigid and each has a certain curved shape, so it could only fit certain types of housings. Therefore, it is desirable to have a universal reflector applicable to light fixtures.

### SUMMARY OF THE INVENTION

An object of the present invention is to provide a retrofit kit for existing recessed light fixtures. The existing recessed light fixtures each has a housing which includes an upper base panel, a first side wall, a second side wall opposite to the first side wall, a third side wall, and a fourth side wall opposite to the third side wall. The first, second, third and fourth side walls extend substantially downward from the upper base panel. An opening is defined by lower edges of the first, second, third and fourth side walls. More specifically, the opening is defined by outer edges of the four side walls considering their thicknesses. For the existing recessed light fixtures which have openings of the same size substantially, they may have housings with various depths and/or configurations. The retrofit kit according to an embodiment of the present invention is applicable to existing recessed light fixtures having openings of the same size. The retrofit kit includes a reflector which is a substantially flat flexible sheet adapted to be flexed to a curved shape against the third and fourth side walls of the housing during installation of the retrofit kit and at least one pair of fasteners adapted to secure the reflector in the housing. The reflector in an embodiment of the present invention is substantially flat, which means it does not have pre-defined curved shape before installation of the retrofit kit. Usually the reflector is made of a metal sheet having a reflecting coating on its surface. As an example, iron sheet is often used.

The reflector in an embodiment of the present invention is a substantially flat flexible sheet which can be flexed and adjusted to fit the housing during installation and make sure there is no gap between the edge of the reflector and the third or fourth side wall of the housing. Comparing with a traditional reflector which is rigid and has a pre-defined curved shape, the flexible reflector in an embodiment of the present invention is applicable to existing recessed light fixtures having openings of the same size and housings of different depths and/or configurations. The size of the reflector is designed based on the opening size of the existing recessed light fixture. As one embodiment of the present invention, the existing recessed light fixture has a rectangular opening with a length L1 and a width W1, wherein L1 is the distance between the lower edges of the first and the second side walls, and W1 is the distance between the lower edges of the third and the fourth side walls. Considering the thickness and different configurations of the housings, L1 and W1 are the outer sizes of the opening. The reflector has a substantially rectangular shape with a length L2 and a width W2 in the range of: 0.9L1<L2<L1; 0.9W1<W2<W1, more particularly, 0.9L1<L2<L1; 0.9W1<W2<0.95W1. In this case, the rectangular reflector having a size of L2 by W2 can be applicable to existing recessed light fixtures which have rectangular openings with the size of L1 by W1.

At least one of the fasteners in the retrofit kit includes a first end adapted to be coupled to the housing through a pivot and a second end extending laterally adapted to secure the reflector through rotating around the pivot. To secure the reflector firmly, the fastener further includes a rod connecting with the second end of the fastener and extending toward the upper base panel of the housing after installation of the fastener. Correspondingly, the reflector has at least one through hole adapted to receive the rod of the fastener extending through.

The retrofit kit in an embodiment of the present invention further comprises a first and a second mounting brackets adapted to be coupled to the housing adjacent to the first and the second side walls of the housing respectively. Specifically, the first and the second mounting brackets can be coupled to the upper base panel or they can be coupled to the first and second side walls of the housing respectively. The reflector is configured to be coupled between the first and the second mounting brackets through at least one pair of fasteners. At least one pair of fasteners includes two fasteners which are adapted to be pre-installed on the first and the second mounting brackets respectively.

The retrofit kit in an embodiment of the present invention further comprises at least one light module, at least one pair of fixing components adapted to secure the at least one light module in the housing, and a power supply component adapted to be coupled to the housing and electrically connected with the at least one light module. As one embodiment of the present invention, at least one light module includes an LED and the power supply component includes an LED driver. As another embodiment of the present invention, at least one light module includes a fluorescent lamp and the power supply component includes a ballast. The fixing components for securing the light module including a fluorescent lamp comprise at least one pair of electrical sockets adapted to electrically connect with the ballast. Each pair of electrical sockets completes a circuit when the fluorescent lamp is coupled between the pair of electrical sockets.

Usually the power supply component will not be seen after installation of the retrofit kit. The power supply component is adapted to be coupled in a space between the reflector and the upper base panel of the housing, or in a space between the first or second mounting bracket and the upper base panel of the housing. Double-sided tape is often used to couple the power supply component to the housing.

The second object in an embodiment of the present invention is to provide a retrofitting method of an existing recessed light fixture. The existing recessed light fixture has a housing which includes an upper base panel, a first side wall, a second side wall opposite to the first side wall, a third side wall, and a fourth side wall opposite to the third side wall. The first, second, third and fourth side walls extend substantially downward from the upper base panel. An opening is defined by lower edges of the first, second, third and fourth side walls. More specifically, the opening is defined by outer edges of the four side walls considering their thicknesses. The retrofitting method in an embodiment of the present invention includes the steps of providing a reflector which is a substantially flat flexible sheet and at least one pair of fasteners adapted to secure the reflector in the housing; and placing the reflector between the first and the second side walls of the housing, adjusting the curved shape of the reflector against the third and fourth side walls of the housing, and securing the reflector using said at least one pair of fasteners.

Usually, the reflector in an embodiment of the present invention has a similar shape with the opening of the existing recessed light fixture. About the size of the reflector, as one embodiment of the present invention, the existing recessed light fixture has a rectangular opening with a length L1 and a width W1, wherein L1 is the distance between the lower edges of the first and the second side walls, and W1 is the distance between the lower edges of the third and the fourth side walls. Considering the thickness and different configurations of the housings, L1 and W1 are the outer sizes of the opening. The reflector has a substantially rectangular shape with a length L2 and a width W2 in the range of: 0.9L1<L2<L1; 0.9W1<W2<W1, more particularly, 0.9L1<L2<L1; 0.9W1<W2<0.95W1.

In certain exemplary embodiments, the retrofitting method further includes the steps of: providing a first and a second mounting brackets; coupling the first and the second mounting brackets to the housing adjacent to the first and the second side walls of the housing respectively; providing at least one light module, at least one pair of fixing components adapted to secure the at least one light module in the housing, and a power supply component; coupling the power supply component to the housing; and coupling the at least one light module between the first and the second side walls of the housing using said at least one pair of fixing components and electrically coupling the light module to the power supply component.

To simplify the retrofitting method, some components of the retrofit kit can be pre-installed on the first and second mounting brackets, such as the at least one pair of fasteners for securing the reflector in the housing, the at least one pair of fixing components for securing the light module in the housing, and the power supply component. Specifically, each pair of fasteners has two fasteners being coupled to the symmetric positions of the first and second mounting brackets respectively. Each pair of fixing components has two fixing components being coupled to the symmetric positions of the first and second mounting brackets respectively.

### BRIEF DESCRIPTION OF THE DRAWINGS

The above and other aspects, features, and advantages of embodiments of the present invention will be described in more detail with reference made to the accompanying drawings, in which:

FIG. 1 is an exploded view of a housing of an existing recessed light fixture and a retrofit kit for the housing in accordance with one embodiment of the present invention;

FIG. 2A is a view of the retrofit kit in FIG. 1 after installation;

FIG. 2B is a section view of the retrofit kit in FIG. 2a taken along line A-A;

FIG. 3 is a perspective view of certain components of the retrofit kit in FIG. 2a;

FIG. 4A is a main view of a retrofit kit in accordance with an alternative embodiment of the present invention;

FIG. 4B is a section view of the retrofit kit in FIG. 4a taken along line A-A.

### DETAILED DESCRIPTION OF THE INVENTION

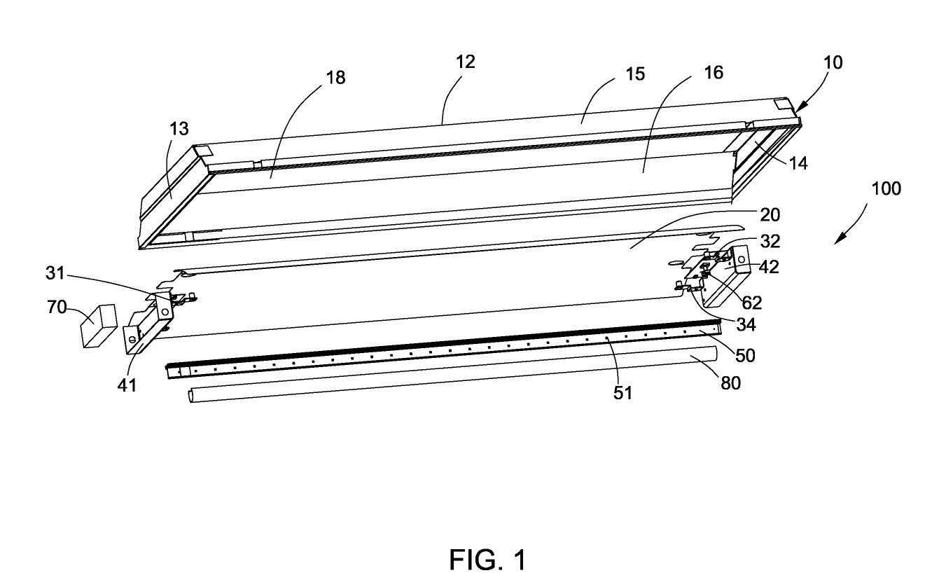

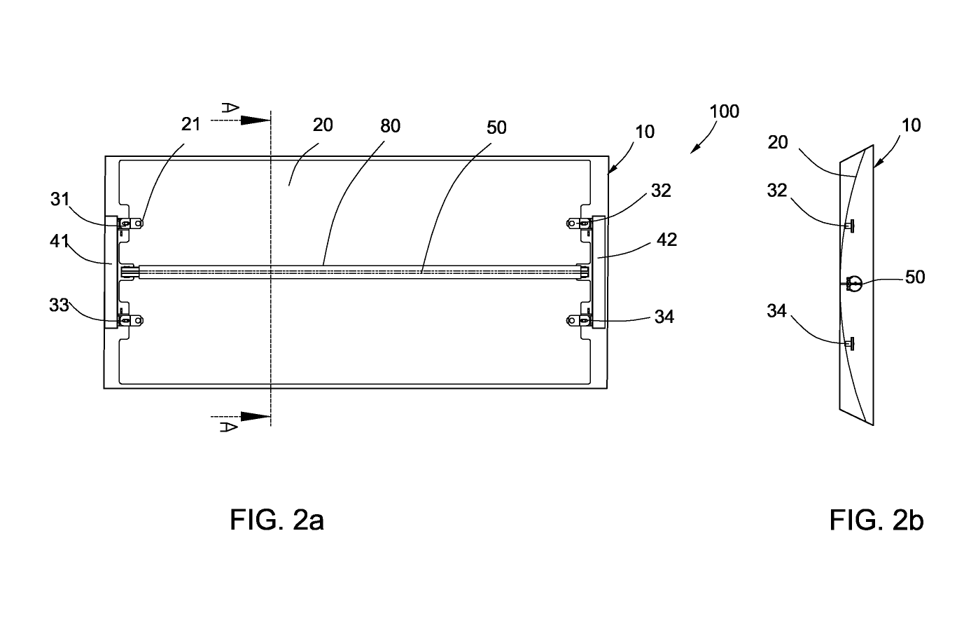

FIG. 1 shows an exploded view of a housing 10 of an existing recessed light fixture mounted in a ceiling plane and a retrofit kit 100 for the housing 10 in accordance with one embodiment of the present invention. The housing 10 includes an upper base panel 12, a first side wall 13, a second side wall 14 opposite to the first side wall 13, a third side wall 15 and a fourth side wall 16 opposite to the third side wall 15. The four side walls 13, 14, 15 and 16 extend substantially downward from the upper base panel 12. A rectangular opening 18 is formed by the lower edges of the four side walls 13, 14, 15 and 16. Other components of the existing recessed light fixture have been removed from the housing 10. As shown in FIG. 1, the housing 10 is retrofitted with the retrofit kit 100. The retrofit kit 100 includes a reflector 20 which is a substantially flat flexible sheet before installation, a first pair of fasteners 31, 32 and a second pair of fasteners 33, 34 (33 is not shown in FIG. 1) adapted to secure the reflector 20 in the housing 10, a first and a second mounting brackets 41, 42, a light module 50, a pair of fixing components 61, 62 (61 is not shown in FIG. 1) adapted to secure the light module 50 in the housing 10, a power supply component 70 and a lens 80. FIG. 2 shows a main view of the retrofit kit 100 after installation.

The reflector 20 has a substantially rectangular shape before installation. As shown in FIG. 1 and FIG. 2a-2b, the reflector 20 is flexed to a curved shape to fit the housing 10 and then it is secured in the housing 10 by two pairs of fasteners 31, 32 and 33, 34. More specifically, the reflector 20 is placed between the first side wall 13 and the second side wall 14 of the housing 10 and is flexed to against the third side wall 15 and fourth side wall 16. Since the reflector 20 of in an embodiment is flexible, it is easy to avoid gap between the reflector 20 and the third side wall 15 or the fourth side wall 16. In an embodiment of the present invention, the existing recessed light fixture has a rectangular opening with a size of 4 ft*2 ft, that is 1219.2 mm*609.6 mm. The reflector 20 in the retrofit kit has a size of 1140 mm*567 mm which is applicable to the existing recessed light fixture.

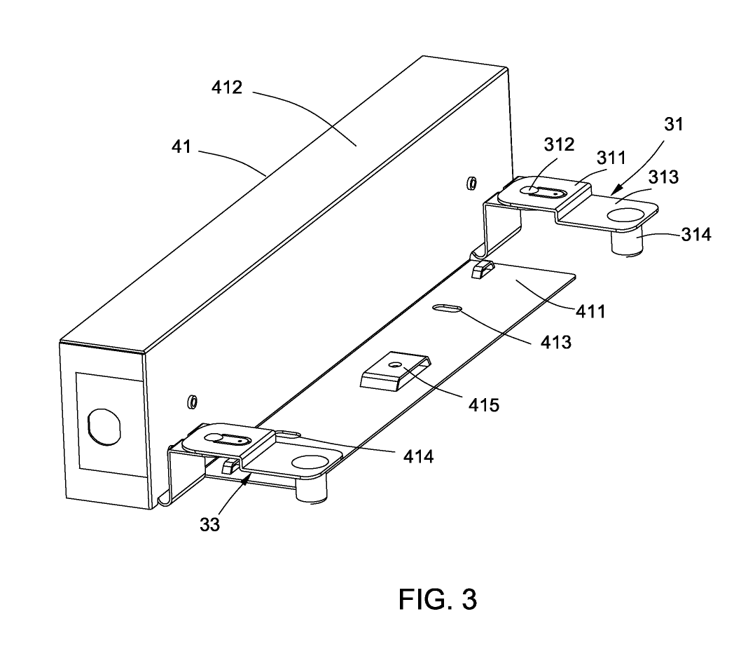

As shown in FIG. 2a, the first pair of fasteners 31, 32 are coupled to symmetric positions of the first mounting bracket 41 and the second mounting bracket 42 respectively. The second pair of fasteners 33, 34 are also coupled to symmetric positions of the first mounting bracket 41 and the second mounting bracket 42 respectively. FIG. 3 shows an enlarged drawing of some components of the retrofit kit 100 including two fasteners 31, 33. The fastener 31 includes a first end 311 adapted to be coupled to the first mounting bracket 41 through a pivot 312, a second end 313 extending laterally, and a rod 314 connected with the second end 313. The rod 314 extends toward the upper base panel 12 of the housing 10 after installation. The second end 313 and the rod 314 of the fastener 31 are used to secure the reflector 20 through rotating around the pivot 312. As shown in FIG. 2a, the reflector 20 has a through hole 21 adapted to receive the rod 314 of the fastener 31 extending through. Thus the reflector 20 can be secured in the housing 10 firmly. The other three fasteners 32, 33, 34 have similar configuration with that of the fastener 31.

The two mounting brackets 41, 42 are adapted to be coupled to the housing 10 adjacent to the first side wall 13 and the second side wall 14 of the housing 10 respectively. Take the mounting bracket 41 as an example, as shown in FIG. 3, the mounting bracket 41 includes a flat portion 411 and a box-shaped portion 412. The flat portion 411 has two through holes 413, 414 for installing the mounting bracket 41 to the housing 10 using tapping screws and a through hole 415 for connecting with the fixing component 61. The mounting bracket 42 has a similar configuration with the mounting bracket 41.

As shown in FIG. 1, the light module 50 of the embodiment includes a plurality of LEDs 51. The light module 50 is configured to be coupled between the first side wall 13 and the second side wall 14 of the housing 10, more specifically, between the first mounting bracket 41 and the second mounting bracket 42 through a pair of fixing components 61, 62. The power supply component 70, which includes an LED driver, is adapted to be coupled to the box-shaped portion 412 of the first mounting bracket 41, so it will not be seen after installation.

As shown in FIG. 1, the retrofitting method of an existing recessed light fixture which has a housing 10 includes the steps of: providing a reflector 20, two pairs of fasteners 31, 32 and 33, 34, a first and a second mounting brackets 41, 42, a light module 50, a pair of fixing components 61, 62, a power supply component 70, and a lens 80, as shown in FIG. 1; coupling the two pairs of fasteners 31, 32, 33, 34 and one pair of fixing components 61, 62 to the first and the second mounting brackets 41, 42; coupling the power supply component 70 to the box-shaped portion 412 of the first mounting bracket 41; coupling the first and the second mounting brackets 41, 42 to the housing 10 adjacent to the first side wall 13 and second side wall 14 respectively; placing the reflector 20 between the first and the second mounting brackets 41, 42, adjusting the curved shape of the reflector 20 against the third side wall 15 and the fourth side wall 16 of the housing 10, and securing the reflector 20 using the fasteners 31, 32, 33, 34; and coupling the light module 50 between the first and the second mounting brackets 41, 42 using the fixing components 61, 62, electrically coupling the light module 50 to the power supply component 70, and coupling the lens 80 to the light module 50.

More specifically, each fastener 31, 32, 33 or 34 is coupled to the mounting brackets 41, 42 through a pivot, as shown in FIG. 3. The fasteners 31, 32 are coupled to symmetric positions of the first and second mounting brackets 41, 42, and the fasteners 33, 34 are also coupled to symmetric positions of the first and second mounting brackets 41, 42. The power supply component 70 is coupled to the box-shaped portion 412 of the first mounting bracket 41 through a double-sided tape. The first and the second mounting brackets 41, 42 are coupled to the housing 10 using tapping screws.

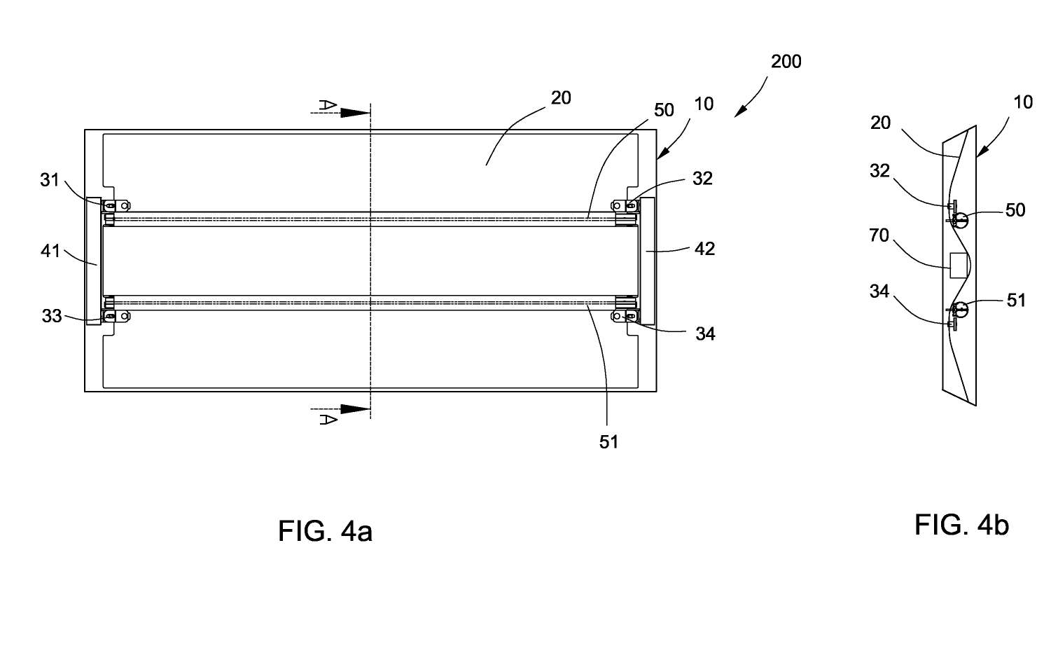

FIG. 4a shows a retrofit kit 200 for an existing recessed light fixture having a housing 10 according to an alternative embodiment of the present invention. The retrofit kit 200 also includes a reflector 20, two pairs of fasteners 31, 32, 33, 34 adapted to secure the reflector 20 in the housing 10, two mounting brackets 41, 42, and a power supply component 70. Different from the retrofit kit 100, the retrofit 200 includes two light modules 50, 51, a first pair of fixing components 61, 62 adapted to secure the light module 50, and a second pair of fixing components 63, 64 adapted to secure the light module 51. During installation, the reflector 20 is placed between the first and second mounting brackets 41, 42 and is flexed to a wave-type shape having two lower portions. FIG. 4b shows a side view of the retrofit kit 200 after installation. The light modules 50, 51 are coupled between the first mounting bracket 41 and the second mounting bracket 42 close to the two lower portions of the reflector 20 respectively. The power supply component 70 is coupled in a space between the upper base panel 12 of the housing 10 and the reflector 20, as shown in FIG. 4b.

This written description uses examples to describe the invention, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A retrofit kit for existing recessed light fixtures, the existing recessed light fixtures each comprising:
a housing, wherein the housing comprises
an upper base panel, a first side wall, a second side wall opposite to the first side wall, a third side wall, and a fourth side wall opposite to the third side wall, the first, second, third and fourth side walls extending substantially downward from the upper base panel, an opening being defined by lower edges of the first, second, third and fourth side walls; and
the retrofit kit comprising a reflector, said reflector is a substantially flat flexible sheet adapted to be flexed to a curved shape against the third and fourth side walls of a housing during installation of the retrofit kit; and at least one pair of fasteners adapted to secure the reflector in the housing.

2. The retrofit kit according to claim 1, wherein the opening of the housing has a rectangular shape with a length (L1) and a width (W1), L1 being the distance between the lower edges of the first and the second side walls, W1 being the distance between the lower edges of the third and the fourth side walls, the reflector has a second rectangular shape with a length (L2) and a width (W2) in the range of: 0.9L1<L2<L1; 0.9W1<W2<W1.

3. The retrofit kit according to claim 1, wherein at least one of the fasteners comprises a first end adapted to be coupled to the housing through a pivot and a second end extending laterally adapted to secure the reflector through rotating around the pivot.

4. The retrofit kit according to claim 3, wherein the fastener further comprises a rod connecting with the second end of the fastener and extending toward the upper base panel of the housing after installation of the fastener, wherein the reflector has at least one through hole adapted to receive the rod of the fastener extending therethrough.

5. The retrofit kit according to claim 1, further comprising:
a first and a second mounting brackets adapted to be coupled to the housing adjacent to the first and the second side walls of the housing respectively, the reflector being coupled between the first and the second mounting brackets through at least one pair of fasteners.

6. The retrofit kit according to claim 1, further comprising:
at least one light module;
at least one pair of fixing components adapted to secure the at least one light module in the housing; and
a power supply component adapted to be coupled to the housing and electrically connected with the at least one light module.

7. The retrofit kit according to claim 6, wherein the at least one light module comprises a light emitting diode.

8. The retrofit kit according to claim 7, wherein the power supply component comprises a light emitting diode driver.

9. The retrofit kit according to claim 6, wherein the at least one light module comprises a fluorescent lamp.

10. The retrofit kit according to claim 9, wherein the power supply component comprises a ballast, the fixing components comprise at least one pair of electrical sockets adapted to electrically connect with the ballast, each pair of electrical sockets completing a circuit when the fluorescent lamp is coupled between the pair of electrical sockets.

11. The retrofit kit according to claim 6, wherein the power supply component is adapted to be coupled in a space between the reflector and the upper base panel of the housing.

12. The retrofit kit according to claim 6, further comprising:
a first and a second mounting brackets adapted to be coupled to the housing adjacent to the first and the second side walls of the housing respectively, the flexiable reflator being coupled between the first and the second mounting brackets through at least one pair of fasteners, the light module being coupled between the first and the second mounting brackets through at least one pair of fixing components.

13. The retrofit kit according to claim 12, wherein the power supply component is adapted to be coupled in a space between one of the first and the second mounting brackets and the upper base panel of the housing.

14. A method of retrofitting an existing recessed light fixture, the existing recessed light fixture having a housing, the housing comprising an upper base panel, a first side wall, a second side wall opposite to the first side wall, a third side wall, and a fourth side wall opposite to the third side wall, the first, second, third and fourth side walls extending substantially downward from the upper base panel, an opening being defined by lower edges of the first, second, third and fourth side walls, the method comprising the steps of:
providing a reflector and at least one pair of fasteners adapted to secure the reflector in the housing, said reflector is a substantially flat flexible sheet; and
placing the reflector between the first and the second side walls of the housing, adjusting the curved shape of the reflector against the third and fourth side walls, and securing the reflector using said at least one pair of fasteners.

15. The method according to claim 14, wherein the opening of the housing has a rectangular shape with a length (L1) and a width (W1), L1 being the distance between the lower edges of the first and second side walls, W1 being the distance between the lower edges of the third and fourth side walls, the reflector has a second rectangular shape with a length (L2) and a width (W2) in the range of: 0.9L1<L2<L1; 0.9W1<W2<W1.

16. The method according to claim 14, further comprising:
providing a first and a second mounting brackets;
coupling at least one pair of fasteners to the first and the second mounting brackets respectively; and
coupling the first and the second mounting brackets to the housing adjacent to the first and the second side walls of the housing respectively.

17. The method according to claim 14, further comprising:
providing at least one light module, at least one pair of fixing components adapted to secure the at least one light module in the housing, and a power supply component;
coupling the power supply component to the housing; and
coupling the at least one light module between the first and the second side walls of the housing using said at least one pair of fixing components and electrically coupling the light module to the power supply component.

18. The method according to claim 17, further comprising:
providing a first and a second mounting brackets;
coupling at least one pair of fasteners to the first and the second mounting brackets respectively; and
coupling the first and the second mounting brackets to the housing adjacent to the first and the second side walls of the housing respectively.
